(19) United States
(12) Patent Application Publication
(10) Pub. No.: US 2015/0300151 A1
(43) Pub. Date: Oct. 22, 2015

(54) SYSTEM AND METHOD PROVIDING REAL-TIME ASSISTANCE TO DRILLING OPERATION

(71) Applicant: Shahab D. Mohaghegh, Morgantown, WV (US)

(72) Inventor: Shahab D. Mohaghegh, Morgantown, WV (US)

(21) Appl. No.: 14/622,589

(22) Filed: Feb. 13, 2015

Related U.S. Application Data
(60) Provisional application No. 61/939,473, filed on Feb. 13, 2014.

(51) Int. Cl. E21B 45/00; G06N 3/04; E21B 47/06; E21B 47/00; E21B 47/10

(52) U.S. Cl. CPC E21B 45/00; E21B 47/0007; E21B 47/10; E21B 47/06; E21B 47/065; G06N 3/0436

(57) ABSTRACT

A system for providing real-time assistance to a drilling operation drilling a bore in the earth, comprising: a computer; a first non-transitory computer-readable medium storing a first program that, when executed by the computer, causes the computer to: receive real-time raw data from sensors monitoring the drilling operation and/or bore; cleanse the real-time raw data including removing any real-time raw data sensed while a drill string of the drilling operation was in a mode of: bit-off-bottom, tripping-in, tripping-out, reaming forward, reaming backward and/or cyclic reaming to produce cleansed data; apply at least a portion of the cleansed data to a neural network that has been trained with information concerning the drilling operation comprising geological information for a part of the earth in which the bore is being drilled; receive from the neural network a prediction in real-time as to the probability of the drilling operation experiencing a condition in the future; and display the prediction.

### CROSS REFERENCE TO RELATED APPLICATIONS

This application claims priority to, and the benefit of, the U.S. provisional patent application U.S. Patent Application Ser. No. 61/939,473 filed on Feb. 13, 2014, which is hereby incorporated by reference in its entirety for all purposes.

### TECHNICAL FIELD OF THE INVENTION

The present disclosure relates generally to drilling a borehole into the earth and, in particular, to maximizing the efficiency of the drilling operation and minimizing None Productive Time (NPT).

### BACKGROUND

Exploration and production of hydrocarbons generally requires that a bore be drilled deep into the earth. The borehole provides access to a geologic formation that may contain a reservoir of oil or gas.

Drilling operations require many resources such as a drilling rig, a drilling crew, and support services. These resources can be very expensive. In addition, the expense can be even much higher if the drilling operations are conducted offshore. Thus, there is an incentive to contain expenses by minimizing NPT and drilling the bore efficiently. Efficiency can be measured in different ways. In one way, efficiency is measured by how fast the borehole can be drilled or rate-of-penetration (ROP). Many difficulties, such as stuck pipe, diminish drilling efficiency and lead to costly NPT. Therefore, what are needed are techniques to optimize ROP while minimizing NPT while drilling a borehole.

Maintaining wellbore stability and monitoring and managing drilling None Productive Time (NPT) are two main key factors in improving safety and drilling efficiency while minimizing costs associated with problems during well construction and production operations. Despite the need to understand the conditions which create drilling operation risks such as wellbore instabilities, there is no industry consensus regarding which stability analysis methodologies are most applicable under varying geological and operational conditions.

Thus, it is desirable to identify and develop best practices for practical drilling troubles prediction (or diagnose signs of troubles ahead of time) as well as provide recommended preventive actions or solutions, including a comprehensive survey of existing methods, assessment of relative priority of data types required and the application of new processes and techniques of applying Artificial Intelligence & Data Mining through preferred systems and methods of the present disclosure.

### SUMMARY OF THE INVENTION

In a preferred aspect, the present disclosure comprises a system for providing real-time assistance to a drilling operation drilling a bore in the earth, comprising: a computer; a first non-transitory computer-readable medium storing a first program that, when executed by the computer, causes the computer to: receive real-time raw data from sensors monitoring the drilling operation and/or bore; cleanse the real-time raw data including removing any real-time raw data sensed while a drill string of the drilling operation was in a mode of: bit-off-bottom, tripping-in, tripping-out, reaming forward, reaming backward and/or cyclic reaming to produce cleansed data; apply at least a portion of the cleansed data to a neural network that has been trained with information concerning the drilling operation comprising geological information for a part of the earth in which the bore is being drilled; receive from the neural network a prediction in real-time as to the probability of the drilling operation experiencing a condition in the future; and display the prediction.

In another preferred aspect of the system of the present disclosure, the information concerning the drilling operation also comprises one or more items selected from the group consisting of: Logging While Drilling information (LWD), Measurement While Drilling information (MWD), mud weight, mud viscosity, mud yield point, mud flow rate, total gas show, drilling fluid type, pump stroke, stand pipe pressure, weight on bit, rpm, hole size, weight on hook, equivalent circulating density, rotary torque, casing pressure, cementing unit pressure, rate of penetration, gamma ray, bulk density, resistivity, sonic velocity, sonic density, spontaneous potential (SP), bit type, bit diameter, bit surface area, bit wear, bit hydraulic power.

In yet another preferred aspect of the system of the present disclosure, the future is expressed in terms of one or more distances ahead of a drill bit of the drilling operation.

In a further preferred aspect of the system of the present disclosure, the condition is selected from the group consisting of non-productive time, bit wear, rate of penetration, stuck pipe, lost circulation, tight hole/spot, high torque, twist off, pressure test failed, oil/gas cutting mud, wellbore hydraulic problem, sidetrack, fish in hole, water flow problem, washout-BHA hole, washout-drill collar.

In another preferred aspect of the system of the present disclosure, the first program, when executed by the computer, further causes the computer to: continually train the neural network with at least a portion of the cleansed data from the drilling operation and/or with cleansed data from one or more nearby drilling operations.

In yet another preferred aspect of the present disclosure, the system further comprises: a second non-transitory computer-readable medium storing a second program comprising a fuzzy logic engine coded with experience information concerning the condition and/or a response or remedy thereto from one or more drilling experts that, when executed by the computer, causes the computer to: apply to the second program at least a portion of the cleansed data and/or the prediction; receive from the second program an advisory output concerning the condition and/or a response or remedy thereto; and display the advisory output.

In another preferred aspect of the system of the present disclosure, the cleansed data comprises one or more items selected from the group consisting of Logging While Drilling information (LWD), Measurement While Drilling information (MWD), mud weight, mud viscosity, mud yield point, mud flow rate, total gas show, drilling fluid type, pump stroke, stand pipe pressure, weight on bit, rpm, hole size, weight on hook, equivalent circulating density, rotary torque, casing pressure, cementing unit pressure, rate of penetration, gamma ray, bulk density, resistivity, sonic velocity, sonic density, spontaneous potential (SP), bit type, bit diameter, bit surface area, bit wear, bit hydraulic power, bit-on-bottom.

In another preferred aspect of the system of the present disclosure, the first and second non-transitory computer-readable mediums are the same or different.

In another preferred aspect of the system of the present disclosure, the cleansed data comprises one or more items selected from the group consisting of: Logging While Drilling information (LWD), Measurement While Drilling information (MWD), mud weight, mud viscosity, mud yield point, mud flow rate, total gas show, drilling fluid type, pump stroke, stand pipe pressure, weight on bit, rpm, hole size, weight on hook, equivalent circulating density, rotary torque, casing pressure, cementing unit pressure, rate of penetration, gamma ray, bulk density, resistivity, sonic velocity, sonic density, spontaneous potential (SP), bit type, bit diameter, bit surface area, bit wear, bit hydraulic power, bit-on-bottom.

In another preferred aspect of the system of the present disclosure, the condition is selected from the group consisting of non-productive time, bit wear, rate of penetration, stuck pipe, lost circulation, tight hole/spot, high torque, twist off, pressure test failed, oil/gas cutting mud, wellbore hydraulic problem, sidetrack, fish in hole, water flow problem, washout-BHA hole, washout-drill collar.

In another preferred aspect of the system of the present disclosure, the first program, when executed by the computer, further causes the computer to: continually train the neural network with at least a portion of the cleansed data from the drilling operation and/or with cleansed data from one or more nearby drilling operations. In yet another preferred aspect of the present disclosure, the system further comprises: a second non-transitory computer-readable medium storing a second program comprising a fuzzy logic engine coded with experience information concerning the condition and/or a response or remedy thereto from one or more drilling experts that, when executed by the computer, causes the computer to: apply to the second program at least a portion of the real-time information and/or the prediction; receive from the second program an advisory output concerning the condition and/or a response or remedy thereto; and display the advisory output.

In another preferred aspect of the system of the present disclosure, the future is expressed in terms of one or more distances ahead of a drill bit of the drilling operation.

In another preferred aspect, the present disclosure comprises a system for providing real-time assistance to a drilling operation drilling a bore in the earth with respect to a condition, comprising: a computer; one or more non-transitory computer-readable medium storing one or more programs, wherein said one or more programs comprises a fuzzy logic engine coded with experience information concerning the condition and/or a response or remedy thereto from one or more drilling experts, wherein when executed by the computer, cause the computer to: receive real-time raw data from sensors monitoring the drilling operation and/or bore, wherein the real-time raw data comprises one or more items selected from the group consisting of: Logging While Drilling information (LWD), Measurement While Drilling information (MWD), mud weight, mud viscosity, mud yield point, mud flow rate, total gas show, drilling fluid type, pump stroke, stand pipe pressure, weight on bit, rpm, hole size, weight on hook, equivalent circulating density, rotary torque, casing pressure, cementing unit pressure, rate of penetration, gamma ray, bulk density, resistivity, sonic velocity, sonic density, spontaneous potential (SP), bit type, bit diameter, bit surface area, bit wear, bit hydraulic power, bit-on-bottom, bit-off-bottom, tripping-in, tripping-out, reaming forward, reaming backward, cyclic reaming; cleanse the real-time raw data including removing any real-time raw data sensed while a drill string of the drilling operation was in a mode of: bit-off-bottom, tripping-in, tripping-out, reaming forward, reaming backward and/or cyclic reaming to produce cleansed data; apply at least a portion of the cleansed data to a neural network that has been trained with information concerning the drilling operation comprising geological information for a part of the earth in which the bore is being drilled and one or more items selected from the group consisting, mud weight, mud viscosity, mud yield point, mud flow rate, total gas show, drilling fluid type; continually train the neural network in real-time with at least a portion of the cleansed data from the drilling operation and/or with cleansed data from one or more nearby drilling operations; receive from the neural network a prediction in real-time as to the probability of the drilling operation experiencing the condition in the future in terms of one or more distances ahead of a drill bit; display the prediction; apply to the fuzzy logic engine the prediction and/or at least a portion of cleansed data; receive from the fuzzy logic engine an advisory output concerning the condition and/or a response or remedy thereto; and display the advisory output. In another preferred aspect of the system of the present disclosure, the condition is selected from the group consisting of NPT, bit wear, rate of penetration, stuck pipe, lost circulation, tight hole/spot, high torque, twist off, pressure test failed, oil/gas cutting mud, wellbore hydraulic problem, sidetrack, fish in hole, water flow problem, washout-BHA hole, washout-drill collar.

### BRIEF DESCRIPTION OF THE DRAWINGS

FIG. 1 illustrates an exemplary embodiment of a computer-controlled drill string disposed in a borehole penetrating the earth.

FIG. 2 shows a schematic illustration of an exemplary drilling advisory system of the present disclosure.

FIG. 3 shows a schematic illustration of an analytics inference module of an exemplary drilling advisory system of the present disclosure.

FIG. 4 shows a schematic illustration of a solution advisory module of an exemplary drilling advisory system of the present disclosure.

FIG. 5 shows a schematic illustration of an exemplary drilling advisory method according to the present disclosure.

### DETAILED DESCRIPTION

In the following detailed description, reference is made to the accompanying examples and figures that form a part hereof, and in which is shown, by way of illustration, specific embodiments in which the subject matter of the present disclosure may be practiced. These embodiments are described in sufficient detail to enable those skilled in the art to practice them, and it is to be understood that other embodiments may be utilized and that structural or logical changes may be made without departing from the scope of the subject matter of the present disclosure. Such embodiments of the subject matter of the present disclosure may be referred to, individually and/or collectively, herein by the term “disclosure” merely for convenience and without intending to voluntarily limit the scope of this application to any single disclosure or concept if more than one is in fact disclosed. The following description is, therefore, not to be taken in a limited sense, and the scope of the subject matter of the present disclosure is defined by the appended claims and their equivalents.

Disclosed are techniques for optimizing a rate-of-penetration while drilling a borehole. The techniques provide for automatically optimizing the rate-of-penetration by using data from sensors monitoring a drill string and controlling at least one input to the drill string based on the data.

The techniques, which include apparatus and methods, use sensors in operable communication with the drill string used for drilling the borehole. The sensors provide data related to the drill string such as vibration or rotational speed at various parts of the drill string. Other sensors may be used to monitor performance of a machine (or drill string motivator) inputting energy or applying a force to the drill string such as a rotary device for turning the drill string.

In addition to the sensors, the techniques use a controller to receive the data from the sensors and for providing a control signal to the drill string motivator to optimize the rate-of-penetration. An optimal rate-of-penetration is generally a function of several variables. Non-limiting examples of these variables include drill bit rotary speed, vertical force applied to the drill bit (weight on bit), the type of drill bit, alignment of the drill bit in the borehole, and the lithology of the formation being drilled. Thus, by optimizing the variables that can be controlled, the rate-of-penetration can also be optimized. For example, one way that the rate-of-penetration can be optimized is to provide the highest weight on bit that still allows the drill bit to rotate above a minimum constant speed (i.e., minimizing speed oscillations). Additionally, the rate-of-penetration can be monitored by measuring the movement of the drill string into the borehole. In one embodiment, the rate-of-penetration can be used as a feedback control signal to the controller. The controller can be located at least one of remote to and at the drill string. In addition, control can be distributed at several locations.

The techniques also provide for detecting an abnormal drilling event and for inputting an appropriate control signal to the drill string motivator to terminate the abnormal drilling event.

For convenience, certain definitions are provided. The term “rate-of-penetration” relates to a distance drilled into the earth divided by a period of time for which the distance was achieved. The term “drill string” relates to at least one of drill pipe and a bottom hole assembly. In general, the drill string includes a combination of the drill pipe and the bottom hole assembly. The bottom hole assembly may be a drill bit, sampling apparatus, logging apparatus, or other apparatus for performing other functions downhole. As one example, the bottom hole assembly can include a drill bit and a drill collar containing measurement while drilling (MWD) apparatus.

The term “vibration” relates to oscillations or vibratory motion of the drill string. A vibration of a drill string can include at least one of axial vibration such as bounce, lateral vibration, and torsional vibration. Torsional vibration can result in the drill bit rotating at oscillating speeds when the drill string at the surface is rotating at a constant speed. Vibration can include vibrations at a resonant frequency of the drill string. Vibration can occur at one or more frequencies and at one or more locations on the drill string. For instance, at one location on the drill string, a vibration at one frequency can occur and at another location, another vibration at another frequency can occur. The term “limit the vibration” relates to providing an input to an apparatus or a system in operable communication with the drill string to at least one of decrease an amplitude of the vibration or change the frequency of the vibration.

The term “sensor” relates to a device for measuring at least one parameter associated with the drill string. Non-limiting examples of types of measurements performed by a sensor include acceleration, velocity, distance, angle, force, moment, temperature, pressure, and vibration. As these sensors are known in the art, they are not discussed in any detail herein.

The term “controller” relates to a control device with at least a single input and at least a single output. Non-limiting examples of the type of control performed by the controller include proportional control, integral control, differential control, model reference adaptive control, model free adaptive control, observer based control, and state space control. One example of an observer based controller is a controller using an observer algorithm to estimate internal states of the drill string using input and output measurements that do not measure the internal state. In some instances, the controller can learn from the measurements obtained from the distributed control system to optimize a control strategy. The term “observable” relates to performing one or more measurements of parameters associated with the motion of the drill string wherein the measurements enable a mathematical model or an algorithm to estimate other parameters of the drill string that are not measured. The term “state” relates to a set of parameters used to describe the drill string at some moment in time.

The term “model reference adaptive control” relates to use of a model of a process to determine a control signal. The model is generally a system of equations that mathematically describe the process. The term “model free adaptive control” relates to controlling a system where equations governing the system are unknown and where a controller is estimated without assuming a model for the system. In general, the controller is constructed using a function approximator such as a neural network or polynomial.

The term “drill string motivator” relates to an apparatus or system that is used to operate the drill string. Non-limiting examples of a drill string motivator include a “lift system” for supporting the drill string, a “rotary device” for rotating the drill string, a “mud pump” for pumping drilling mud through the drill string, an “active vibration control device” for limiting vibration of the drill string, and a “flow diverter device” for diverting a flow of mud internal to the drill string. The term “weight on bit” relates to the force imposed on the bottom hole assembly such as a drill bit. Weight on bit includes a force imposed by the lift system and an amount of force caused by the flow mud impacting on the bottom hole assembly. The flow diverter and mud pump, therefore, can affect weight on bit by controlling the amount of mud impacting the bottom hole assembly. The term “optimizing a rate-of-penetration” relates to providing a control signal from a controller to a drill string motivator to obtain substantially the highest rate-of-penetration. Generally, an optimized rate-of-penetration is commensurate with preventing damage to drilling equipment.

The term “broadband communication system” relates to a system for communicating in real time. The term “real time” relates to transmitting a signal downhole with little time delay. The broadband communication system generally uses electrical conductors or a fiber optic as a transmission medium. As used herein, transmission of signals in “real-time” is taken to mean transmission of the signals at a speed that is useful or adequate for optimizing the rate-of-penetration. Accordingly, it should be recognized that “real-time” is to be taken in context, and does not necessarily indicate the instantaneous transmission of measurements or instantaneous transmission of control signals.

The term “couple” relates to at least one of a direct connection and an indirect connection between two devices. The team “decoupling” relates to accounting for process interactions (static and dynamic) in a controller.

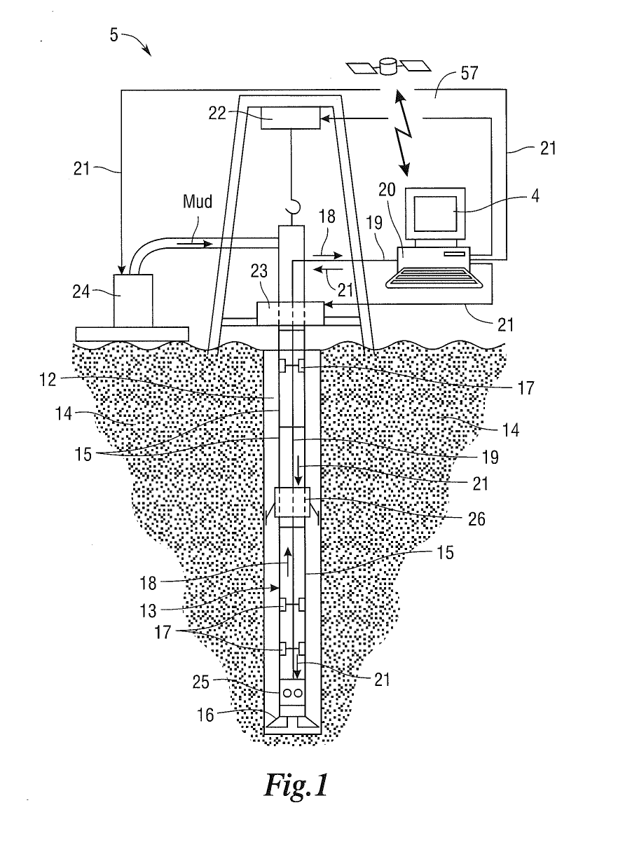

FIG. 1 illustrates an exemplary embodiment of a drilling operation 5 including drill string 13 disposed in a borehole 12 penetrating the earth 14. The borehole 12 can penetrate a geologic formation that includes a reservoir of oil or gas. The drill string 13 includes drill pipe 15 and a bottom hole assembly 16. The bottom hole assembly 16 can include a drill bit or drilling device for drilling the borehole 12. In the embodiment of FIG. 1, a plurality of sensors 17 are disposed along a length the drill string 13. The plurality of sensors 17 measures aspects related to operation of the drill string 13, such as motion of the drill string 13. A broadband communication system 19 transmits data 18 from the sensors 17 to a controller 20. The data 18 includes measurements performed by the sensors 17. The controller 20 is configured to provide a control signal 21 to a drill string motivator. The broadband communication system 19 can include a fiber optic or “wired pipe” for transmitting the data 18 and the control signal 21.

In one embodiment of wired pipe, the drill pipe 15 is modified to include a broadband cable protected by a reinforced steel casing. At the end of each drill pipe 15, there is an inductive coil, which contributes to communication between two drill pipes 15. In this embodiment, the broadband cable is used to transmit the data 18 and the control signal 21. About every 500 meters, a signal amplifier is disposed in operable communication with the broadband cable to amplify the communication signal to account for signal loss.

One example of wired pipe is INTELLIPIPE® commercially available from Intellipipe of Provo, Utah, a division of Grant Prideco. One example of the broadband communication system 19 using wired pipe is the INTELLISERV® NETWORK also available from Grant Prideco. The Intelliserv Network has data transfer rates from fifty-seven thousand bits per second to one million bits per second or more. The broadband communication system 19 enables sampling rates of the sensors 17 at up to 200 Hz or higher with each sample being transmitted to the controller 10 at a location remote from the sensors 17.

Various drill string motivators may be used to operate the drill string 13. The drill string motivators depicted in FIG. 1 are a lift system 22, a rotary device 23, a mud pump 24, a flow diverter 25, and an active vibration control device 26. Each of the drill string motivators depicted in FIG. 1 are coupled to the controller 20. The controller 20 can provide the control signal 21 to each of these drill string motivators to control at least one aspect of their operation. For example, the control signal 21 can cause the lift system 22 to impart a certain force on the drill string 13. The controller 20 can also control: the rotary device 23 to at least one of control the rotational speed of the drill string 3 and control the torque imposed on the drill string 13; the flow of mud from the mud pump 24; the amount of mud diverted by the flow diverter 25; and operation of the active vibration control device 26.

The drilling advisory system of the present disclosure (referred to herein as “Modern, Intelligent Drilling Advisory System (MIDAS)”) of the present disclosure is useful in minimizing the None Productive Time (NPT) and increasing the Rate of Penetration (ROP) using (partially) the real-time data generated during the drilling operation to predict drilling troubles and enhance drilling efficiency by implementing corrective actions to minimize or avoid such drilling troubles.

MIDAS performs analysis, prediction and knowledge management in real-time in order to increase drilling efficiency and anticipate upcoming drilling troubles. MIDAS preferably will recommend activities in real-time to increase drilling efficiency and solutions to prevent the predicted troubles while minimizing the potential risks associated with each presented solution. MIDAS preferably will monitor the drilling operation and assist in optimizing the drilling operation 24/7.

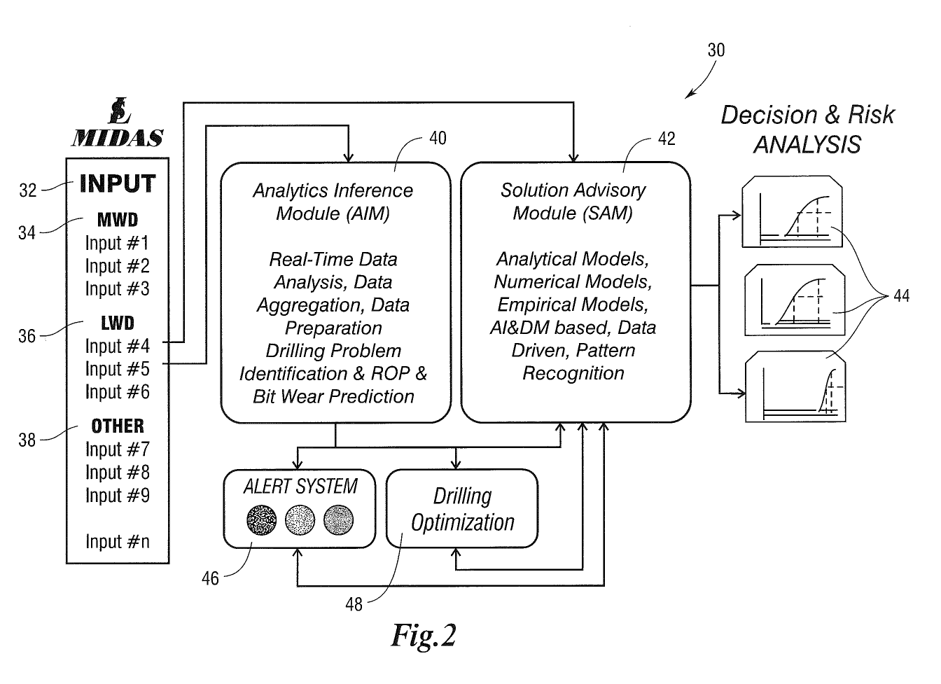

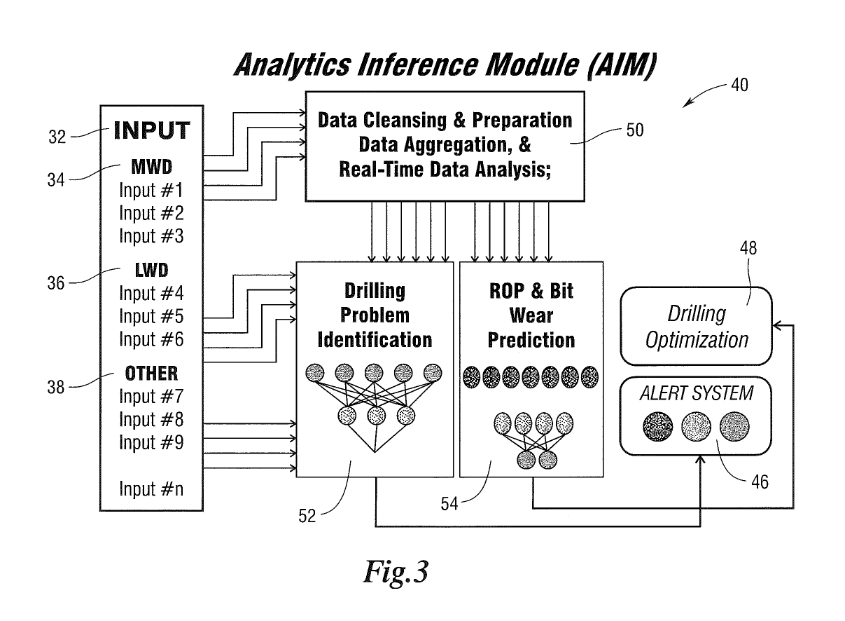

As shown in FIGS. 2-3, the MIDAS 30 of the present disclosure preferably comprises an analytics inference module (AIM) 40 including an artificial neural network (ANN) that is trained, tested and validated with historical geological data for the field being drilled. MIDAS 30 of the present disclosure also preferably comprises a solution advisory module (SAM) 42 which incorporates a data-knowledge fusion paradigm 56 and fuzzy logic engine 57 coded valuable existing operational knowledge from drilling experts as well as other experts in the industry. This knowledge-base (that will grow with time) will be available in MIDAS 30 of the present disclosure as a redundant check and in order to compensate for the occasions where historical data are not sufficient for drilling trouble prediction purposes.

Preferably, MIDAS 30 is tested or calibrated on a minimum of five selected drilling rigs in different fields. MIDAS 30 preferably will be useful in all types of drilling locations and operations in the industry.

According to preferred aspects of the present disclosure, optimization of drilling operations is performed automatically and in real-time, including but are not limited to: optimization of Bit-Wear to increase life of bit and minimize the number of trips required for bit changes.

Minimization of None Productive Time (NPT) such as Stuck Pipe, Bottom-Hole Assembly Problems, etc. Following is a partial list of targeted drilling conditions or troubles to be minimized in accordance with the present disclosure: Lost Circulation, Tight Hole/Spot, Stuck Pipe, High Torque, Twist Off, Pressure Test Failed, Oil/Gas Cutting Mud, Wellbore Hydraulics, Sidetrack, Fish In Hole, Water Flow, Washout-BHA/Hole, Washout-Drill Collar, and Optimization of Rate of Penetration (ROP) by maximizing the rate while minimizing operational risks and safety. Such conditions are interactive and interdependent which is taken into account in the MIDAS 30 of the present disclosure.

Data used in MIDAS 30 of the present disclosure preferably includes real-time data from the sensors that are installed in the drilling equipment. Logging While Drilling (LWD) and Measurement While Drilling (MWD) are included in the real-time data that is used by MIDAS 30 in various aspects of the present disclosure for aiding in the drilling process. Above and beyond the LWD and MWD MIDAS takes full advantage of Mud Logs, Mud Design, Casing and Bit Design, Drill Cutting Analysis, and any and all the data relevant to the drilling process whether it is collected in real-time, during the operation and/or in advance of the drilling during the design process.

Furthermore, driller's experience in dealing with NPT (None-Productive Time) and ROP (Rate of Penetration) and BW (Bit Wear) are recorded in natural language and preferably used in by MIDAS 30 using Drilling Data-Knowledge Fusion process described herein. Preferably, MIDAS 30 using all data, information and/or knowledge that is in any shape or form relevant to drilling. Following is a partial list of data used preferably used in MIDAS 30: the real-time information comprises one or more items selected from the group consisting of: mud weight, mud viscosity, mud yield point, mud flow rate, total gas show, drilling fluid type, pump stroke, stand pipe pressure, weight on bit, rpm, hole size, weight on hook, equivalent circulating density, rotary torque, casing pressure, cementing unit pressure, rate of penetration, gamma ray, bulk density, resistivity, sonic velocity, sonic density, spontaneous potential (SP), bit type, bit diameter, bit surface area, bit wear, bit hydraulic power, bit-on-bottom, bit-off-bottom, tripping-in, tripping-out, reaming forward, reaming backward, and cyclic reaming.

Drilling data collected and used in MIDAS 30 (especially those that are collected in real-time) is usually in the form of numerical values (integers and/or real numbers). To successfully predict NPT, ROP and BW, identify the proper solutions, and recommend the best possible solutions with potential confidence on their success, the collected data preferably is integrated and processed along with the best drilling knowledge that is available at any given time. The available knowledge-base by nature preferably is in the form of words and concepts and not generally in the form of numerical values. Therefore, integration of knowledge with data requires computation with words that is integrated with conventional computation with numbers. This integration is called “Data-Knowledge Fusion, DKF”. In MIDA 30, DKF is used to combine the data collected in real-time as well as other numerical data with knowledge-base (that is continuously being enhanced by using MIDAS 30 on multiple operator platforms) in order to identify the best course of action as solution to a potential NTP, or to accurately predict BW and/or optimize ROP.

Preferably, MIDAS 30 is an evergreen system. It continuously collects data during the drilling operation (all data that is used as input in MIDAS 30). During this process the main database of MIDAS is continuously enhanced and replenished with new data 32. Furthermore, MIDAS 30 updates itself as necessary, while it is used by operators. The learning engines 40 and 42 in MIDAS 30 are continuously and automatically assessed to determine if new information has been collected. This is performed via continuous evaluation of the degree of accuracy of MIDAS's predictions. If new information and data has been collected during the course of a specific operation, then MIDAS 30 will determine that it needs to be re-trained in order to learn the new information. The retraining process includes two modes of manual and automatic re-training. Automatic re-training takes place by MIDAS 30 (sometimes in real-time if necessary) either during operation (if necessary) or during any rest time between operations. The manual re-training is performed regularly by professionals upon routine assessment of MIDAS's performance. Every foot that is drilled anywhere in the world using MIDAS 30, contributes to the overall performance of MIDAS 30 in the future.

Data and knowledge used by MIDAS 30 is stored and continuously updated in a data/knowledge-base. Two implementations of the data/knowledge-base are incorporated in MIDAS 30 in order to cater to different preferences in the industry. These are Comprehensive and Single-Source databases.

The Single-Source database is operator specific and therefore, includes data from a single operator. Data and information from the Single-Source database is not combined with data collected from any other operator or shared with any other operator that might be using MIDAS 30.

The Comprehensive database is a shared database between all operators. The Comprehensive database combines data from all operators that choose to participate in the Comprehensive database program for the purposes of creating the most intelligent global drilling system possible in MIDAS 30. Preferably, the Comprehensive database is used to regularly re-train the main engines within MIDAS 30. Those that choose to participate in the Comprehensive database program will have the privilege of using the most recently updated MIDAS 30 engines. The data and knowledge sharing within the Comprehensive database preferably is accomplished with full anonymity to protect the proprietary data and information belonging to certain basins or reservoirs operated by specific operators.

It has been long established that the characteristics of the formation being drilled into plays an important role in all related drilling issues. This includes problems that cause NPT, as well as the Rate of Penetration (ROP) and Bit-Wear (BW). Therefore, MIDAS 30 preferably employs a new and innovative system comprising a “Live Geological Model” to predict (with reasonable accuracy) the characteristics of the geological formations ahead of the bit real-time as part of and in order to predict of NPT, ROP and BW ahead of the drill bit.

A Live Geological Model—LGM is an ever-green geological model that is updated in real-time by MIDAS 30 using all available data including, and most importantly, the data from the LWD.

A geological model is developed based on the existing wells as control points using geology and geo-statistical techniques to interpret formation continuity between wells and then is updated and re-interpreted (between wells) as new wells are drilled and LWD becomes available. The LGM is an important part of the MIDAS 30. It allows MIDAS 30 to know what it to expect (in terms of formation characteristics and as a results well logs such as Density, GR . . . ) ahead of the bit. MIDAS 30 uses this information (taking note of the uncertainties associated with such interpretations) and makes predictions regarding NPT, ROP and BW and preferably then quantifies the uncertainties associated with the predictions it has made.

The formation characteristics interpreted (predicted) by MIDAS 30 using the Live Geological Model are sent to the data-driven predictive models, AIM 40 and SAM 42 that have multiple inputs for predicting NPT, ROP and BW several feet ahead of the bit. Several of the inputs to the predictive model are related to the formation characteristics while other inputs include MWD characteristics and other available information.

Live Geological Model by nature is uncertain. Modules in MIDAS 30 that are used to predict the formation characteristics ahead of the bit and incorporate these information during the real-time predictive analytics of NPT, ROP and BW preferably have small computational foot-prints. As such, large number of predictions can be made in very small amount of time, making it possible and practical for MIDAS 30 to perform uncertainty analysis (quantification of uncertainties associated with the Live Geological Model), thus making MIDAS 30 a realistic real-time drilling management tool.

MIDAS 30 preferably makes predictions using machine learning including artificial neural networks. The networks are initially trained on historical data and are updated and retrained as new data becomes available from new drilling operations and are stored in the MIDAS 30 databases 32, 34, 36 and 38.

Preferably, MIDAS 30 includes an application that monitors the entire drilling operation 5 from the start to the end in real-time, while interacting with drilling operators to enhance drilling efficiency and to solve potential problems.

While doing this, MIDAS 30 includes an evergreen software application that is also collecting new data, learning from the ongoing operations and degrees of their successes and failures in order to enrich its knowledge-base, its database of events (32, 34, 36 and 38) and when necessary re-train, recalibrate and re-validate all its models. Furthermore, MIDAS 30 continuously learns from its own interaction with the engineers and operators in order to perform better and more efficiently and intelligently during upcoming drilling operations.

MIDAS 30 receives and stores all relevant data including information regarding the mud, the bit, the formation and all the mechanical issues in real-time data such as MWD, LWD and any and all real-time drilling surveys (ROP, Weight on bit, Torque, etc. . . . ) sending them through an autonomous and adaptive data quality control process to remove outliers and noise (data cleansing) and perform data abstraction and summarization and to prepare the data for real-time modeling and analysis as at 50. Such real-time data preferably is augmented with all other relevant data and information including the type of the hardware used at any given time, casing design, mud design, geological interpretation of the type, the thickness and the sequence of formations present, information from the cuttings and the pit, and all other relevant information and data from engineering and geology. This information feeds continuously updating databases (32, 34, 36 and 38) that serve as the main data and information warehouse for MIDAS 30.

Data cleansing and data abstraction processes that are essential steps in processing and preparation of the real-time data take place within AIM 40, in a sub-module 50 (Data Management). Upon pre-processing of the real-time data, the Data Management submodule 50 aggregates and complements the real-time data with other relevant static and dynamic data before handing them over to the analytics sub-module of AIM 40. More specifically, the Data Management submodule 50 preferably removes any data associated with functions of the drill string 13 such as tripping-in, tripping-out, reaming forward, reaming backward, and cyclic reaming and other non-primary operations or functions of the drill string 13.

FIG. 3 shows a schematic illustration of AIM 40 of MIDAS 30 of the present disclosure. The analytics sub-module AIM 40 is trained to detect any unusual patterns and behavior in the real-time data that is constrained with the augmented static and dynamic data. AIM's analytics sub-module is a multi-stage system that performs a series of analysis. The first step only detects regular and safe operations (based on historical data as well as expert knowledge). It provides a safe conduit through AIM 40 for the data that is indicatory of safe operations, while initiating or maintaining the Status=Green in the alarm system 46.

Upon detection of irregular patterns in the real-time data the analytics sub-module of AIM 40 attempts to identify the problem using a comprehensive, adaptive, and intelligent classification procedure. Many of the problems have analytical, numerical and/or empirical solutions. Furthermore, one of the major tasks of MIDAS 30 includes comprehensive analysis of previous incidents using existing drilling operation databases. Preferably, MIDAS 30 contains data-driven models as well as Fuzzy Inference Engines to address all types of drilling troubles that have been present in such databases.

The data and information from the database are used in the “Analytics Inference Module (AIM)” 40 that preferably includes multiple, parallel sets of models, algorithms and inference engines that consist of analytical, numerical, and empirical as well as AI&DM-based (Artificial Intelligence and Data Mining) data driven, pattern recognition and fuzzy knowledge-based models and analytics. These systems, collectively and collaboratively, will determine the potential for increasing drilling efficiency and anticipate and detect any potential problems with the operation. The “Analytics Inference Module (AIM)” 40 preferably is managed, in real-time, by multiple autonomous subroutines of MIDAS 30. The result of the analyses of AIM 40 is used by MIDAS 30 to identify: (1) whether and how the drilling process can be optimized through processes such as ROP enhancement or efficiency in bit-wear prediction, and (2) if a problem can be anticipated (predicted) to happen in the near future (within “x” feet ahead of the bit), as the drilling operations are continued in its current mode.

Such predictions are directed to the SAM module 42 to make a decision based on the information provided by AIM 40. FIG. 2 shows the general workflow of MIDAS 30.

As far as the prediction of drilling troubles is concern, MIDAS 30 uses the results from AIM 40 to trigger one of the following three alarms statuses on a display such as at 4 or 46 (the Alarm System):
Status=Green:
No problems are anticipated, continue operation.
Status=Orange:
Potential problems are anticipated within “x” ft. ahead of the bit; the solution module is activated for further instruction.
Status=Red:
Problem is imminent; operator is advised to halt operation.

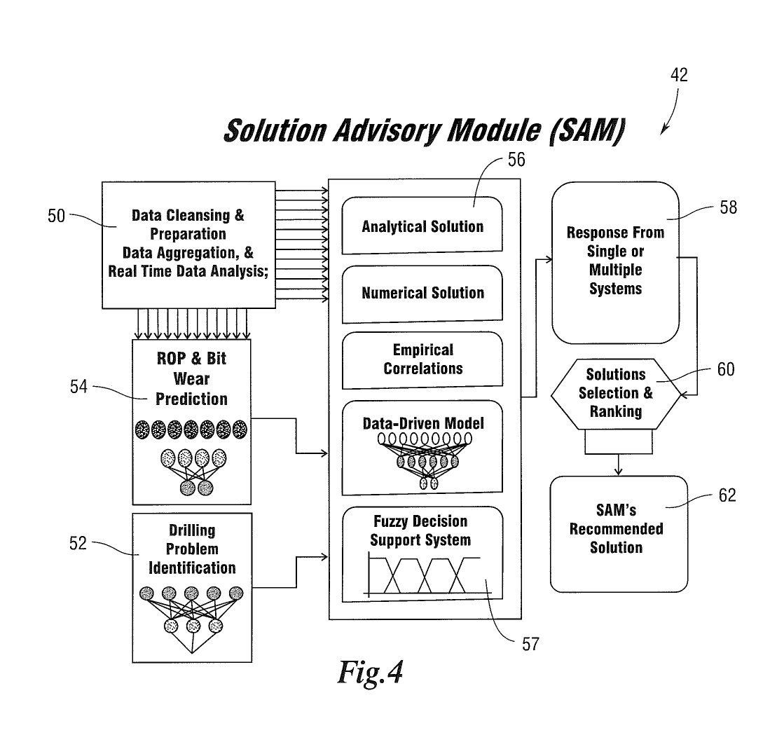

In operation, decisions number 2 (Status=Orange) and 3 (Status=Red) of AIM 40 activate the SAM module 42 of MIDAS 30. FIG. 4 shows a schematic illustration of SAM module 42 of the present disclosure.

SAM 42 employs a fuzzy logic engine to identify multiple solutions with any given potential problem that is detected by MIDAS 30 during the drilling process. The solutions are comprehensively analyzed based on the degree of risk that is associated with their implementation. The solutions are then ranked and presented along with the risk probabilities that are associated with each.

SAM 42 is responsible for a series of actions preferably including: identification and ranking of the possible solutions to enhance drilling efficiency and/or the anticipated problem. The solutions are ranked based on viability to solve and address the anticipated problems and on the probability of success and involved risks. Such ranking is performed by algorithms in MIDAS 30 that make it possible to perform a large number of model runs for sensitivity, uncertainty and risk analysis, in a very short period of time. The final decision 62 by SAM 42 is presented to the user of the system, for instance on display 4. SAM 42 can also be configured to alarm certain individuals associated with the drilling operation 5 with a series of communications that include Emails, text messages (SMS), or phone calls via wireless communications 57. Furthermore, SAM 42 preferably updates its results as a function of time and operational advances and monitors the drilling operation 5 in order to modify the state of the anticipated problem as displayed on 4. For instance, the state of a given problem can be displayed as:

Resolved; either from actions taken by the operator or by changes in the operational situations,

Maintained; no changes have taken place and degree of anticipated problems are maintained,

Intensified; anticipated problem has been intensified requiring immediate action. This may have happened either by lack of action from the operator, or by insufficiency of the solution that was recommended and implemented.

As far as real-time ROP optimization is concerned, MIDAS 30 preferably develops a geological model of the basin where the drilling is implemented. This geological model is developed based on the available information regarding all the layers present (from surface to the target pay) and is refined as a function of well logs that generated upon drilling of every well in the basin. Therefore, the geological model of MIDAS 30 is an ever improving model of the layers present in the basin, interpolating between existing wells for the places where no well exists. Such continuously improving geological model provides input (albeit uncertain—uncertainty will reduces as drilling of every individual well is completed) to MIDAS 30 for predicting ROP several feet ahead of the bit (with a band of uncertainty). This allows MIDAS 30 to recommend changes (refinement) in drilling operation (weight on bit, torque, etc.) in order to increase ROP to its maximum allowable for the given rock while maximizing safety and minimizing possibilities of NPT occurrence.

MIDAS 30 thus increase the effectiveness of drilling engineers in monitoring and predicting drilling troubles, while increasing drilling efficiency. The target solutions for MIDAS 30 will improve drilling operations in the following ways: Improve Drilling Safety, Avoid/Reduce None Productive Time (NPT), Increase Drilling Efficiency, Reduce Well Control Incidents, Monitor Hole Cleaning, Avoid Kicks, Prevent or Minimize Fluid losses, and Reduce the Occurrence of Stuck Pipe Incidents.

The two systems of drilling that MIDAS preferably applies to are: Rotary Strearable Systems and Mud Motor systems.

A comprehensive inventory of available data (digital, real-time, geology, design, etc.,) that expected to be available in all wells to be compiled by MIDAS 30 for two types of zones, namely, Time Zones and Distance Zones preferably may include: ID, Date Time, Hole Depth, Bit Position, Block Height, Bit Weight, Hook Load, Top Drive RPM, Top Drive Torque, String Speed, ROP—Average, Pump SPM—Total, Flow In Rate, Flow Out Percent, Differential Pressure, Pump Pressure, Mud Weight In, Gain Loss, Gamma Ray, Bit Off bottom (ft), Flag Bit Stopped, Flag Downward, Flag Rotation, Flag Circulation, Flag Trip, Flag Ream, Flag Rotary Drill, Flag Slide Drill, Flag Other, Distance from NPT, Time from NPT, Flag Zone Z NPT, Flag Zone T NPT, Xing Total, Xing Trip, Xing Ream, Drill Time, Drill RPM, Drill Torque, Drill WOB, Drill HLoad, Drill ROP, Drill SSpeed, LastX Time, LastX RPM, LastX Torque, LastX WOB, LastX HLoad, LastX SSpeed, Last 15 min—Hload, Last 15 min—Torque, Last 15 min—ROP, Last 15 min—Sspeed, Last 15 min—RPM, Last 15 min—WOB, Ahead 10 ft—Xing Total, Ahead 10 ft—Xing Trip, Ahead 10 ft—Xing Ream, Ahead 10 ft—Drill Time (mins), Ahead 10 ft—Drill RPM, Ahead 10 ft—Drill Torque, Ahead 10 ft—Drill WOB, Ahead 10 ft—Drill HLoad, Ahead 10 ft—Drill ROP, Ahead 10 ft—Drill SSpeed, Ahead 10 ft—LastX Time (mins), Ahead 10 ft—LastX RPM, Ahead 10 ft—LastX Torque, Ahead 10 ft—LastX WOB, Ahead 10 ft—LastX HLoad, and Ahead 10 ft—LastX SSpeed.

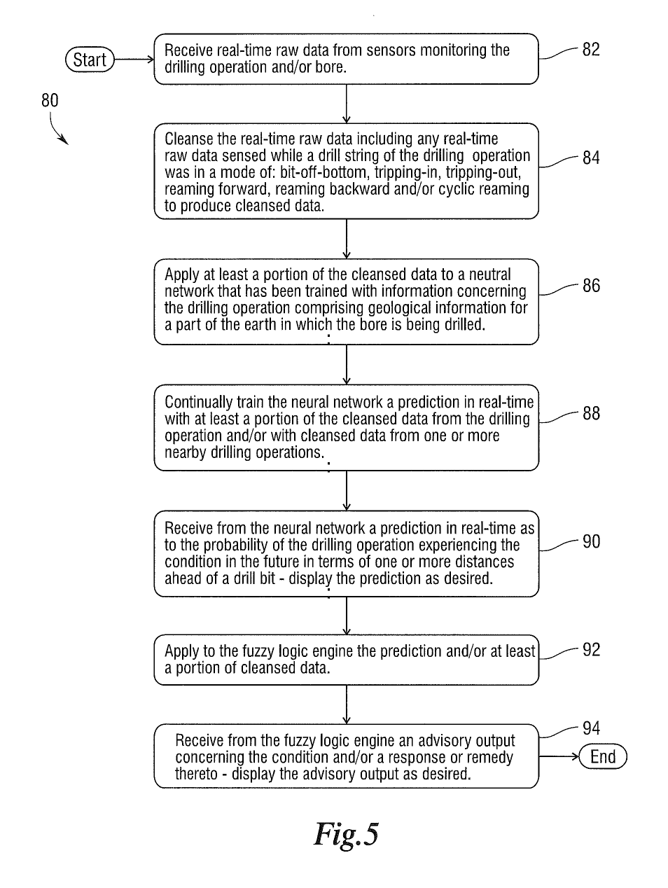

FIG. 5 illustrates a preferred computer-implemented method 80 for assisting a drilling operation, which preferably may be performed by a system according to the present disclosure, comprising the steps of:

receiving real-time raw data from sensors monitoring the drilling operation and/or bore as at 82;

cleansing the real-time raw data including removing any real-time raw data sensed while a drill string of the drilling operation was in a mode of: bit-off-bottom, tripping-in, tripping-out, reaming forward, reaming backward and/or cyclic reaming to produce cleansed data as at 84;

applying at least a portion of the cleansed data to a neural network that has been trained with information concerning the drilling operation comprising geological information for a part of the earth in which the bore is being drilled as at 86;

continually training the neural network in real-time with at least a portion of the cleansed data from the drilling operation and/or with cleansed data from one or more nearby drilling operations as at 88;

receiving from the neural network a prediction in real-time as to the probability of the drilling operation experiencing the condition in the future in terms of one or more distances ahead of a drill bit—display the prediction as desired as at 90;

applying to the fuzzy logic engine the prediction and/or at least a portion of cleansed data as at 92; and

receiving from the fuzzy logic engine an advisory output concerning the condition and/or a response or remedy thereto—display the advisory output as desired as at 94.

In the foregoing Detailed Description, various features are grouped together in a single embodiment to streamline the disclosure. This method of disclosure is not to be interpreted as reflecting an intention that the claimed embodiments of the disclosure require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system for providing real-time assistance to a drilling operation drilling a bore in the earth, comprising:
a computer;
a first non-transitory computer-readable medium storing a first program that, when executed by the computer, causes the computer to:
receive real-time raw data from sensors monitoring the drilling operation and/or bore;
cleanse the real-time raw data including removing any real-time raw data sensed while a drill string of the drilling operation was in a mode of: bit-off-bottom, tripping-in, tripping-out, reaming forward, reaming backward and/or cyclic reaming to produce cleansed data;
apply at least a portion of the cleansed data to a neural network that has been trained with information concerning the drilling operation comprising geological information for a part of the earth in which the bore is being drilled;
receive from the neural network a prediction in real-time as to the probability of the drilling operation experiencing a condition in the future; and
display the prediction.

2. The system of claim 1 wherein the information concerning the drilling operation also comprises one or more items selected from the group consisting of: Logging While Drilling information (LWD), Measurement While Drilling information (MWD), mud weight, mud viscosity, mud yield point, mud flow rate, total gas show, drilling fluid type, pump stroke, stand pipe pressure, weight on bit, rpm, hole size, weight on hook, equivalent circulating density, rotary torque, casing pressure, cementing unit pressure, rate of penetration, gamma ray, bulk density, resistivity, sonic velocity, sonic density, spontaneous potential (SP), bit type, bit diameter, bit surface area, bit wear, bit hydraulic power.

3. The system of claim 1 wherein the future is expressed in terms of one or more distances ahead of a drill bit of the drilling operation.

4. The system of claim 1 wherein the condition is selected from the group consisting of non-productive time, bit wear, rate of penetration, stuck pipe, lost circulation, tight hole/spot, high torque, twist off, pressure test failed, oil/gas cutting mud, wellbore hydraulic problem, sidetrack, fish in hole, water flow problem, washout-BHA hole, washout-drill collar.

5. The system of claim 1 wherein the first program, when executed by the computer, further causes the computer to: continually train the neural network with at least a portion of the cleansed data from the drilling operation and/or with cleansed data from one or more nearby drilling operations.

6. The system of claim 1 further comprising:
a second non-transitory computer-readable medium storing a second program comprising a fuzzy logic engine coded with experience information concerning the condition and/or a response or remedy thereto from one or more drilling experts that, when executed by the computer, causes the computer to:
apply to the second program at least a portion of the cleansed data and/or the prediction;
receive from the second program an advisory output concerning the condition and/or a response or remedy thereto; and
display the advisory output.

7. The system of claim 1 wherein the cleansed data comprises one or more items selected from the group consisting of Logging While Drilling information (LWD), Measurement While Drilling information (MWD), mud weight, mud viscosity, mud yield point, mud flow rate, total gas show, drilling fluid type, pump stroke, stand pipe pressure, weight on bit, rpm, hole size, weight on hook, equivalent circulating density, rotary torque, casing pressure, cementing unit pressure, rate of penetration, gamma ray, bulk density, resistivity, sonic velocity, sonic density, spontaneous potential (SP), bit type, bit diameter, bit surface area, bit wear, bit hydraulic power, bit-on-bottom.

8. The system of claim 6 wherein the first and second non-transitory computer-readable mediums are the same or different.

9. The system of claim 2 wherein the cleansed data comprises one or more items selected from the group consisting of: Logging While Drilling information (LWD), Measurement While Drilling information (MWD), mud weight, mud viscosity, mud yield point, mud flow rate, total gas show, drilling fluid type, pump stroke, stand pipe pressure, weight on bit, rpm, hole size, weight on hook, equivalent circulating density, rotary torque, casing pressure, cementing unit pressure, rate of penetration, gamma ray, bulk density, resistivity, sonic velocity, sonic density, spontaneous potential (SP), bit type, bit diameter, bit surface area, bit wear, bit hydraulic power, bit-on-bottom.

10. The system of claim 9 wherein the condition is selected from the group consisting of non-productive time, bit wear, rate of penetration, stuck pipe, lost circulation, tight hole/spot, high torque, twist off, pressure test failed, oil/gas cutting mud, wellbore hydraulic problem, sidetrack, fish in hole, water flow problem, washout-BHA hole, washout-drill collar.

11. The system of claim 10 wherein the first program, when executed by the computer, further causes the computer to: continually train the neural network with at least a portion of the cleansed data from the drilling operation and/or with cleansed data from one or more nearby drilling operations.

12. The system of claim 11 further comprising:
a second non-transitory computer-readable medium storing a second program comprising a fuzzy logic engine coded with experience information concerning the condition and/or a response or remedy thereto from one or more drilling experts that, when executed by the computer, causes the computer to:
apply to the second program at least a portion of the real-time information and/or the prediction;
receive from the second program an advisory output concerning the condition and/or a response or remedy thereto; and
display the advisory output.

13. The system of claim 10 wherein the future is expressed in terms of one or more distances ahead of a drill bit of the drilling operation.

14. A system for providing real-time assistance to a drilling operation drilling a bore in the earth with respect to a condition, comprising:
a computer;
one or more non-transitory computer-readable medium storing one or more programs, wherein said one or more programs comprises a fuzzy logic engine coded with experience information concerning the condition and/or a response or remedy thereto from one or more drilling experts, wherein when executed by the computer, cause the computer to:
receive real-time raw data from sensors monitoring the drilling operation and/or bore, wherein the real-time raw data comprises one or more items selected from the group consisting of: Logging While Drilling information (LWD), Measurement While Drilling information (MWD), mud weight, mud viscosity, mud yield point, mud flow rate, total gas show, drilling fluid type, pump stroke, stand pipe pressure, weight on bit, rpm, hole size, weight on hook, equivalent circulating density, rotary torque, casing pressure, cementing unit pressure, rate of penetration, gamma ray, bulk density, resistivity, sonic velocity, sonic density, spontaneous potential (SP), bit type, bit diameter, bit surface area, bit wear, bit hydraulic power, bit-on-bottom, bit-off-bottom, tripping-in, tripping-out, reaming forward, reaming backward, cyclic reaming;
cleanse the real-time raw data including removing any real-time raw data sensed while a drill string of the drilling operation was in a mode of: bit-off-bottom, tripping-in, tripping-out, reaming forward, reaming backward and/or cyclic reaming to produce cleansed data;
apply at least a portion of the cleansed data to a neural network that has been trained with information concerning the drilling operation comprising geological information for a part of the earth in which the bore is being drilled and one or more items selected from the group consisting, mud weight, mud viscosity, mud yield point, mud flow rate, total gas show, drilling fluid type;
continually train the neural network in real-time with at least a portion of the cleansed data from the drilling operation and/or with cleansed data from one or more nearby drilling operations;
receive from the neural network a prediction in real-time as to the probability of the drilling operation experiencing the condition in the future in terms of one or more distances ahead of a drill bit;
display the prediction;
apply to the fuzzy logic engine the prediction and/or at least a portion of cleansed data;
receive from the fuzzy logic engine an advisory output concerning the condition and/or a response or remedy thereto; and
display the advisory output.

15. The system of claim 14 wherein the condition is selected from the group consisting of NPT, bit wear, rate of penetration, stuck pipe, lost circulation, tight hole/spot, high torque, twist off, pressure test failed, oil/gas cutting mud, wellbore hydraulic problem, sidetrack, fish in hole, water flow problem, washout-BHA hole, washout-drill collar.
